(19) United States
(12) Patent Application Publication
(10) Pub. No.: US 2021/0269119 A1
(43) Pub. Date: Sep. 2, 2021

(54) DRIVE SYSTEM OF AN ELECTRICALLY OPERABLE BICYCLE

(71) Applicant: Robert Bosch GmbH, Stuttgart (DE)

(72) Inventors: Kai Oliver Boehnke, Bad Urach (DE); Sigmund Braun, Kusterdingen (DE); Rolando Doelling, Hechingen (DE); Stefan Holst, Filderstadt (DE)

(21) Appl. No.: 17/274,002

(22) PCT Filed: Nov. 12, 2019
(86) PCT No.: PCT/EP2019/080922

§ 371 Date: Mar. 5, 2021

(30) Foreign Application Priority Data
Nov. 21, 2018 (DE) 10 2018 219 898.5

(51) Int. Cl. B62M 6/55; B62K 19/34

(52) U.S. Cl. CPC B62M 6/55; B62K 19/34

(57) ABSTRACT

A drive system of an electrically operable bicycle. The drive system includes an electric drive including a housing, at least one first mounting part and a second mounting part, which are fastened at the housing and are configured for being fastened at a frame component of the bicycle, the first mounting part being situated at a first side of the electric drive, and the second mounting part being situated at a second side of the electric drive, opposite the first side.

### FIELD

The present invention relates to a drive system of an electrically operable bicycle and to a bicycle including such a drive system, in particular a pedelec or an s-pedelec.

### BACKGROUND INFORMATION

Bicycles operable with the aid of muscle power and/or an electrical auxiliary drive are recently becoming increasingly popular in the form of pedelecs and s-pedelecs. Here, in particular, the so-called mid-drive motor concept has gained acceptance, in which the electric drive is situated in the area of the driving shaft of the bicycle. A mounting of the electric drive at the frame takes place via a fixed frame interface, which is integrated into the frame. The fixation of the electric drive usually takes place via screws directly at the frame component. This principle has basically been proven due to its simplicity. It would be desirable, however, to have further improvements here.

### SUMMARY

A drive system of an electrically operable bicycle according to an example embodiment of the present invention may have the advantage over the related art that a connection to highly diverse frame geometries is possible in an easy way. Here, according to an example embodiment of the present invention, a standardized electric drive including a housing may be utilized and an adaptation takes place via at least one first mounting part and one second mounting part. The mounting parts are fastened at the housing of the electric drive and are configured for being fastened at a frame of the bicycle. As a result, it is possible to select individual mounting parts for highly diverse frames and, therefore, provide a connection of a standardized electric drive at the frame. The first mounting part is situated at a first side of the electric drive and the second mounting part is situated at a second side of the electric drive, opposite the first side. Therefore, the electric drive may be fixed at the frame from two sides, preferably its longitudinal sides, and it is not necessary to provide an adapted housing of the electric drive for different frames. Bicycle manufacturers may therefore freely select an interface to the electric drive and a geometric adaptation takes place via the mounting parts, in order to fix the electric drive at the frame.

Preferred refinements and embodiment of the present invention are disclosed herein.

In accordance with an example embodiment of the present invention, the first mounting part and the second mounting part include first passage openings and second passage openings, the first passage openings being configured for accommodating connecting parts, the connecting parts fastening the first mounting part and the second mounting part at the frame component and the second passage openings being configured for accommodating connecting parts, the connecting parts being configured for fastening the first mounting element and the second mounting element at the housing.

Preferably, the first mounting element and the second mounting element each include at least one first flat area and one second flat area, which are connected to each other via a transition area. The first flat area is situated in a first plane and the second flat area is situated in a second plane, the two planes being in parallel to one another. The first mounting part and the second mounting part are a flat component, in particular a sheet-like flat component. Due to the design of the flat component having two parallel planes offset with respect to each other, a good damping effect of the mounting part may be obtained, so that a decoupling of the electric drive from the frame via the first mounting part and the second mounting part is possible. Oscillations or vibrations, or the like, may be absorbed and damped between the two flat areas, in particular with the aid of the transition area.

Preferably, each mounting part includes first passage openings and second passage openings. The first passage openings are configured for accommodating connecting parts, in particular screws, or the like, which fasten the mounting part at the housing of the electric drive. The second passage openings are configured for accommodating connecting parts, in order to fasten the first mounting part and the second mounting part at the frame of the bicycle.

It is particularly preferred when all first passage openings are situated in first flat areas in the first plane and all second passage openings are situated in second flat areas of the second plane. As a result, a particularly good damping effect may be achieved by the first and second mounting parts.

It is particularly preferred when the drive system includes an even number of mounting parts, in particular exactly two mounting parts or exactly four mounting parts or exactly six mounting parts. An equal number of mounting parts is preferably situated on one side, in particular the longitudinal side, of the drive system. The mounting parts are preferably each designed as one piece. Preferably, the mounting parts are sheet-metal parts, particularly preferably aluminum sheet-metal parts.

According to one further preferred embodiment of the present invention, the first and second mounting parts each partially project beyond the housing and define, between each other, a receiving space, through which an electrical connection of the electric drive extends to a power store situated at the frame or another component of the bicycle.

Preferably, there is an overlap of greater than 50%, preferably greater than 60%, particularly preferably greater than 75% between the first mounting part and/or the second mounting part and the electric drive, in a top view, in parallel to a central axis of a driving shaft.

The housing of the electric drive preferably encompasses magnesium and/or a magnesium compound and/or aluminum and, particularly preferably, is made completely of magnesium or a magnesium compound or aluminum.

According to one further preferred example embodiment of the present invention, a nut, in particular an insert nut, is fixed at the mounting part or at least one passage opening of the mounting part includes a thread. As a result, a simple bolted connection between the components is possible.

According to one further preferred example embodiment of the present invention, the drive system further includes a damping element, which is situated between the mounting part and the housing and/or between the mounting part and the frame of the bicycle.

The damping element is preferably a decoupling nut, which encompasses an inelastic base body and an elastic buffer body. The elastic buffer body is situated at the inelastic base body and includes a cylindrical inner area. The inner area of the decoupling nut is configured for accommodating and fixing a connecting part, in particular a fixing screw, or the like. The inelastic base body is preferably made of the same material as the mounting part, in particular aluminum. The elastic buffer body is preferably an elastomer. It is particularly preferred when a crown is situated at at least one passage opening at the first mounting part and/or the second mounting part, in order to accommodate the decoupling nut. As a result, the decoupling nut may be situated at the mounting part in an easy way.

Further preferably, the drive system further includes a spring element, in particular a spring steel sheet, which is situated between the first mounting part and/or the second mounting part and the housing of the electric drive and/or between the first mounting part and/or the second mounting part and the frame of the bicycle. The spring steel sheet preferably has a thickness, which is less than the thickness of the first mounting part and/or the second mounting part. The spring element has the additional task of decoupling oscillations, vibrations, and the like, and prevents their transfer to the frame of the bicycle. It is particularly preferred when the intermediate sheet has the same outer contour as the first mounting part and/or the second mounting part.

The present invention further relates to a bicycle, in particular a pedelec or an s-pedelec. According to the present invention, the term “bicycle” is to be understood to mean not only a two-wheeled bicycle, but also, for example, a three-wheeled bicycle or a cargo bicycle including two or three wheels or a bicycle including four wheels, for example, for handicapped persons. The electric drive is preferably situated, as a mid-drive motor, at the bicycle and, particularly preferably, encompasses a driving shaft of the bicycle.

### BRIEF DESCRIPTION OF THE DRAWINGS

Preferred exemplary embodiments of the present invention are described in detail below with reference to the figures.

FIG. 1 shows a schematic exploded representation of a drive system and a portion of a frame of the bicycle, in accordance with an example embodiment of the present invention.

FIG. 2 shows a perspective representation of the drive system from FIG. 1.

FIG. 3 shows a perspective representation of the frame component for the connection of the drive system from FIG. 1, in accordance with an example embodiment of the present invention.

FIGS. 4 through 6 show schematic representations of an alternative possibility for connecting the electric drive onto the frame component, in accordance with example embodiments of the present invention.

FIG. 7 shows a schematic, perspective partial view of a drive system according to a second exemplary embodiment, in accordance with the present invention.

FIG. 8 shows a schematic sectional representation of a mounting part of the drive system from FIG. 7.

### DETAILED DESCRIPTION OF EXAMPLE EMBODIMENTS

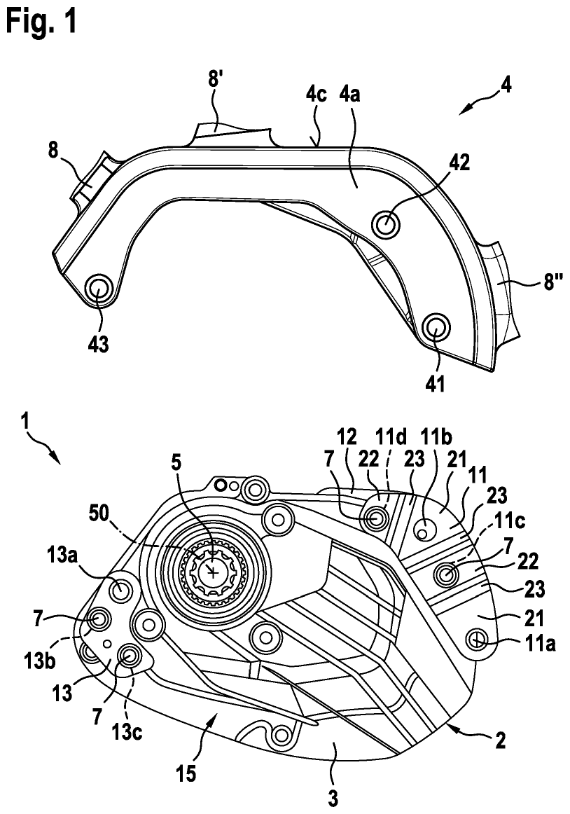

A drive system 1 of an electrically operable bicycle is described in detail in the following with reference to FIGS. 1 through 3.

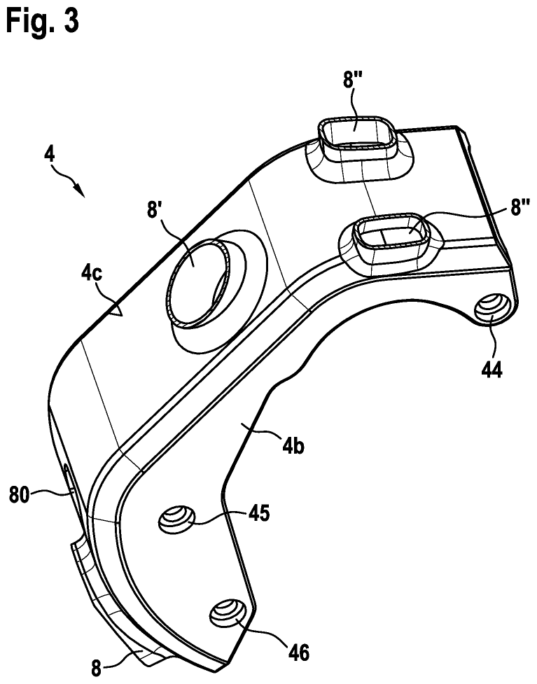

FIG. 1 schematically shows an exploded representation of an electric drive 2 and a frame component 4 of the bicycle, onto which electric drive 2 is fixed. A down tube 8, a seat tube 8′, and two chain stays 8″ are schematically indicated at frame component 4 in FIGS. 1 and 3. Moreover, an opening 80 is also situated in frame component 4 for the through-routing of electrical cables, or the like, for an electrical connection of electric drive 2 to a power store at the bicycle.

Electric drive 2 includes a housing 3, which, in this exemplary embodiment, is weight-optimized and is preferably made of magnesium and/or magnesium compounds and/or aluminum. Moreover, a driving shaft 5 is also indicated at electric drive 2, which is also enclosed by housing 3 of electric drive 2.

A total of six fastening openings 41, 42, 43, 44, 45, 46 are provided at frame component 4. Frame component 4 includes a first side frame 4a and a second side frame 4b, which are connected to each other via a connecting part 4c. Side frames 4a and 4b are in parallel to one another. Three fastening openings are provided in each side frame 4a, 4b.

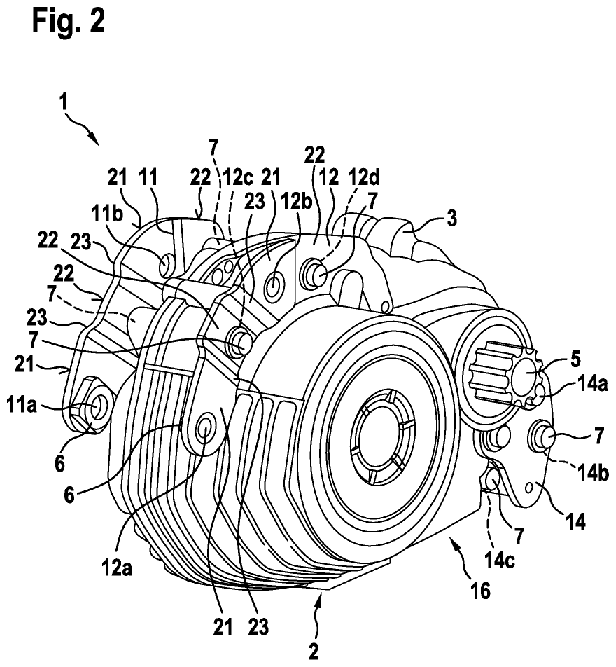

In this exemplary embodiment, a first mounting part 11, a second mounting part 12, a third mounting part 13, and a fourth mounting part 14 are provided for the connection between frame component 4 and electric drive 2. As is apparent, in particular, from FIG. 2, first mounting part 11 and second mounting part 12 are situated at housing 3 opposite one another at a first longitudinal side 15 and a second longitudinal side 16. Third mounting part 13 and fourth mounting part 14 are also situated opposite one another at housing 3.

A plurality of passage openings is provided in each of the mounting parts 11, 12, 13, 14. Each of the mounting parts 11, 12, 13, 14 includes a first passage opening 11a, 11b, 12a, 12b, which is configured for enabling a fastening at the electric drive and a second passage opening 11c, 11d, 12c, 12d, which is configured for enabling a fastening at frame component 4.

As is apparent, in particular, from FIG. 2, first mounting part 11 includes exactly two first passage openings 11a, 11b, first passage openings 11a and 11b being configured for fixation at the frame component and fastening openings 11c and 11d being configured for fixation at housing 3 of electric drive 2.

Similarly, second mounting part 12 includes first and second passage openings 12a, 12b, 12c, and 12d. The two first passage openings 12a and 12b are configured for fastening at frame component 4 and second passage openings 12c and 12d are configured for fastening at housing 3 of electric drive 2.

FIGS. 1 and 2 show the state of mounting parts 11, 12, 13, 14, in which these are fastened at housing 3 of electric drive 2 with the aid of connecting parts 7 in the form of fixing screws. First passage openings 11a, 11b and 12a, 12b for fixation at frame component 4 are also represented without [a] connecting part.

As shown in FIG. 2, nuts 6 including a female thread are situated at first passage openings 11a, 11b and 12a, 12b for the fixation at frame component 4 (shown only at passage openings 11a, 12a), with the aid of which a screw, which are [sic; is] routed through fastening openings 41, 42 and 44, 45 of the frame component, is fastenable. Alternatively, it is also possible that passage openings 11a, 11b and 12a, 12b each include a female thread.

As is further apparent from FIG. 2, first mounting part 11 and second mounting part 12 have a wavelike configuration in such a way that first flat areas 21 and second flat areas 22 are formed in each case. The first and second flat areas are in parallel to one another and are connected to each other via connecting areas 23. As is apparent from FIGS. 1 and 2, first passage openings 11a, 11b and 12a, 12b are each situated at first flat areas 21 for fastening at frame component 4. Passage openings 11c, 11d and 12c, 12d for fastening at housing 3 of the electric drive are situated at second flat areas 22.

First flat areas 21 and second flat areas 22 are situated in alternation. Due to this geometric shape of mounting parts 11, 12, a decoupling between frame component 4 and housing 3 of electric drive 2 may be ensured. In particular, oscillations and vibrations, which could arise during the operation of electric drive 2, may not be transferred to the frame. Therefore, the frame of the bicycle and electric drive 2 are decoupled from one another, so that a user does not perceive an operation of the electric drive.

As further shown in FIGS. 1 and 2, three passage openings 13a, 13b, 13c and 14a, 14b, and 14c are also provided at third mounting part 13 and fourth mounting part 14, respectively. First passage openings 13a and 14a are configured for connection to frame component 4 and second passage openings 13b, 13c and 14b, 14c are configured for connection to housing 3 of electric drive 2.

Therefore, first mounting part 11 and third mounting part 13 are each situated at a first longitudinal side 15 of the electric drive and second mounting part 12 and fourth mounting part 14 are situated opposite one another at a second longitudinal side 16 of the electric drive.

It is to be noted that the third mounting part 13 and the fourth mounting part 14 are also preferably designed in a wavelike manner including two flat areas, which are situated in planes in parallel to one another.

The passage openings in mounting parts 11, 12, 13, 14 are in parallel to a central axis 50 of driving shaft 5.

Moreover, due to the use of the mounting parts between electric drive 2 and frame component 4, a tolerance compensation, also of greater tolerances, may be made possible. Mounting parts 11, 12, 13, 14 may be slightly deformed during assembly. Mounting parts 11, 12, 13, 14 are preferably made of aluminum and housing 3 of the electric drive preferably encompasses magnesium and/or magnesium compounds. As a result, mounting parts 11, 12, 13, 14 may also provide a material decoupling between frame component 4 and electric drive 2, so that the risk of corrosion is eliminated.

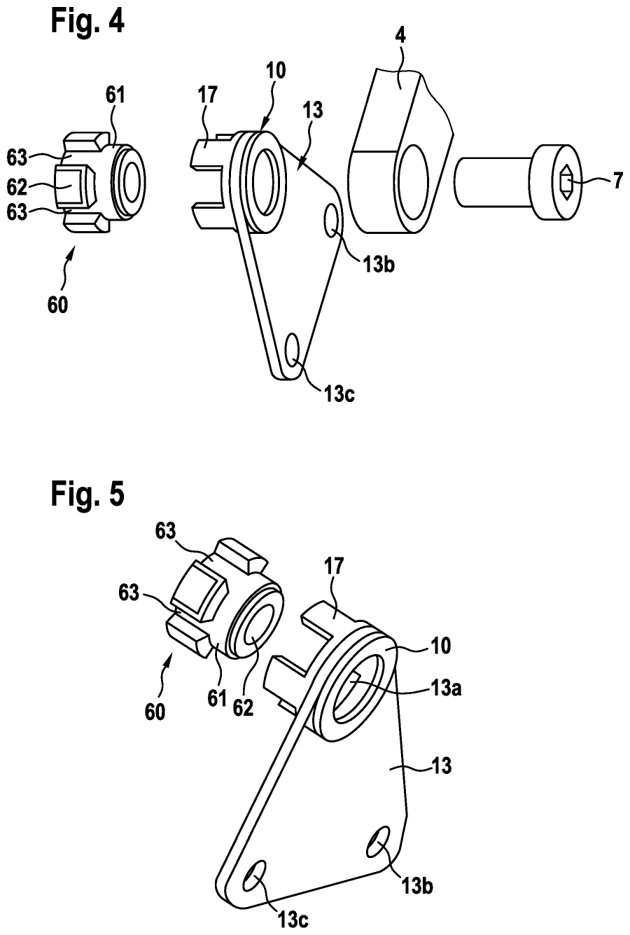

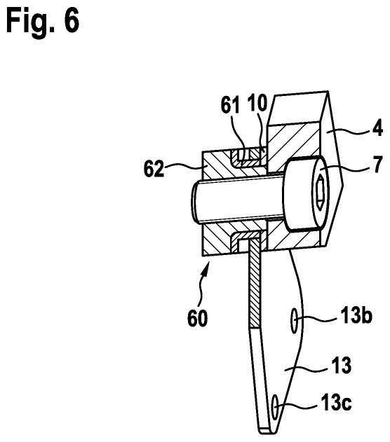

In FIGS. 4 through 6, an alternative mounting possibility between electric drive 2 and frame component 4 is schematically represented, identical parts and functionally identical parts being labeled with the same reference numerals as in the first exemplary embodiment. Instead of providing nut 6 at the mounting part, which, in the first exemplary embodiment, is fixed at the mounting part, for example, with the aid of a welded joint or, alternatively, a rivet connection or a crimp connection, a decoupling nut 60 is provided in the exemplary embodiment represented in FIGS. 4 through 6. Decoupling nut 60 encompasses an inelastic base body 61 and an elastic buffer body 62. Moreover, a crown 17 is welded or, alternatively, riveted or pressed, onto mounting part 13. Decoupling nut 60 includes intermediate spaces 63, which accommodate the teeth of the crown 17. The assembled state is shown in FIG. 6. Connecting part 7 is therefore completely accommodated at elastic buffer body 62, so that no direct contact is present between frame component 4 and housing 3 of electric drive 2. During the tightening of connecting part 7, crown 17 ensures that decoupling nut 60 does not also rotate. This connection between connecting part 7 and elastic buffer body 62 is detachable and reusable without loss.

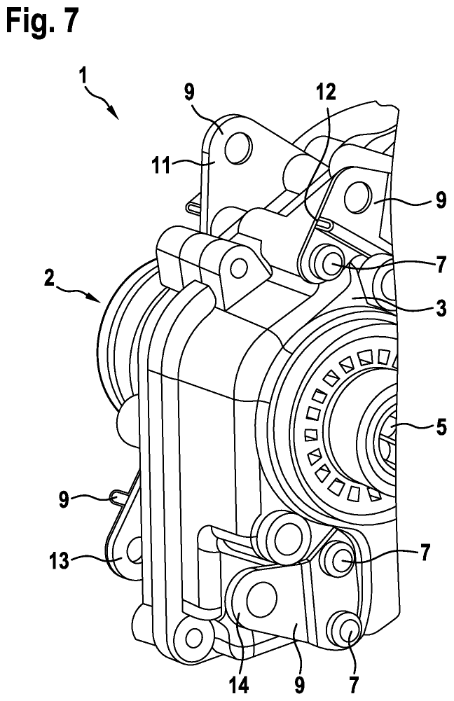

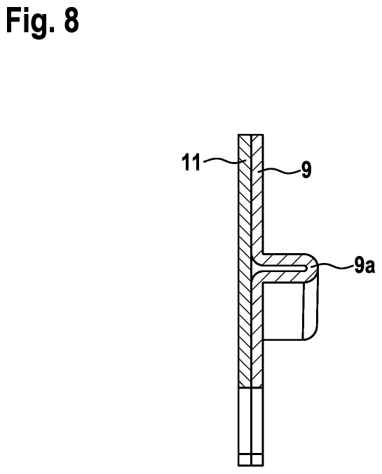

In FIGS. 7 and 8, a drive system 1 according to a second exemplary embodiment of the present invention is represented. The second exemplary embodiment essentially corresponds to the first exemplary embodiment, a flat spring element 9 being additionally situated at mounting parts 11, 12, 13, 14 in the second exemplary embodiment, in contrast to the first exemplary embodiment. Spring element 9 is in direct contact with each mounting part and is preferably made of spring steel sheet or aluminum sheet. Further preferably, a thickness of spring element 9 is less than a thickness of the particular mounting part. As is apparent from FIG. 7, spring element 9 is situated at mounting parts 11, 12, 13, 14 in such a way that spring element 9 is in contact with frame component 4 in the assembled state in each case. Moreover, folds 9a are provided at spring element 9 in each case (cf. FIG. 8), which improve the spring properties of spring elements 9. Mounting parts 11, 12, 13, 14 are preferably made of aluminum. It is also possible, however, that, due to the use of spring elements 9, mounting parts 11, 12, 13, 14 are made of steel or of plastic, since spring elements 9 prevent direct contact between mounting parts 11, 12, 13, 14 and frame component 4. An outer contour of spring elements 9 preferably corresponds to an outer contour of mounting parts 11, 12, 13, 14.

Otherwise, this exemplary embodiment corresponds to the preceding exemplary embodiment, so that reference may be made to the description provided there.

Therefore, according to the present invention, an improved decoupling may be achieved between electric drive 2 and frame 4 of a bicycle including an electric drive. Although, as compared to the related art, an additional component is provided between electric drive 2 and the frame, considerable advantages are achieved as a result, since, in addition to a possible simple tolerance compensation and a simple adaptation to different frame components 4, a decoupling is also achieved between the electric drive 2 and the frame component 4 of the bicycle. Oscillations, vibrations, and structure-borne noise are therefore no longer transferred from electric drive 2 to the frame of the bicycle, but rather are damped by mounting parts 11, 12, 13, 14. Connecting mounting parts 11, 12, 13, 14 are very easily held and are very cost-effectively manufacturable as mass-produced components.

1-14. (canceled)

15. A drive system for an electrically operable bicycle, comprising:
an electric drive including a housing; and
at least one first mounting part and at least one second mounting part, which are fastened at the housing and are configured for being fastened at a frame component of the bicycle, wherein the first mounting part is situated at a first side of the electric drive, and the second mounting part is situated at a second side of the electric drive, opposite the first side.

16. The drive system as recited in claim 15, wherein the first mounting part and the second mounting part each include first passage openings and second passage openings, the first passage openings being configured to accommodate connecting parts, the connecting parts fastening the first mounting part and the second mounting part at the frame component and the second passage openings being configured to accommodate second connecting parts, the second connecting parts being configured to fasten the first mounting part and the second mounting part at the housing.

17. The drive system as recited in claim 15, wherein the first mounting part and the second mounting part are each a flat component, and include at least a first flat area and a second flat area, which are connected to each other via a transition area, the first flat area and the second flat area are in parallel to one another.

18. The drive system as recited in claim 17, wherein the first mounting part and the second mounting part are each a flat sheet.

19. The drive system as recited in claim 17, wherein the transition area is configured to absorb and dampen oscillations or vibrations between the two first and second flat areas, A transfer of oscillations and vibrations from the drive to the frame component being damped in the process.

20. The drive system as recited in claim 17, wherein all of the second passage openings which are configured for connection to the frame component, are situated at the first flat area and all first passage openings, which are configured for connection to the housing of the electric drive, being situated at the second flat area.

21. The drive system as recited in claim 15, wherein a number of the first and second mounting parts is even.

22. The drive system as recited in claim 15, wherein the first mounting part and/or the second mounting part partially projects beyond the housing and, between each other, define a receiving space, through which an electrical connection of the electric drive extends to a power store of the bicycle.

23. The drive system as recited in claim 21, wherein there is an overlap in an area of greater than 50% between each of the first and second mounting parts and the housing, in a top view, in parallel to a central axis of a driving shaft.

24. The drive system as recited in claim 15, wherein a nut is situated at each of the first and second mounting part or at least one passage opening of the first and second mounting parts includes a female thread.

25. The drive system as recited in claim 15, further comprising:
a damping element situated between the first and second mounting parts and the housing and/or between the first and second mounting parts and the frame component.

26. The drive system as recited in claim 25, wherein the damping element is a decoupling nut, which encompasses an inelastic base body and an elastic buffer body, which is situated at the inelastic base body and includes a cylindrical inner area, the cylindrical inner area being configured for accommodating and fixing a connecting part.

27. The drive system as recited in claim 26, wherein the first mounting part and/or the second mounting part includes a crown at a passage opening for accommodating the decoupling nut.

28. The drive system as recited in claim 15, further comprising:
a spring element situated between the first mounting part and the second mounting part and the housing and/or between the first mounting part and the second mounting part and the frame component.

29. The drive system as recited in claim 28, wherein the spring element is a spring steel sheet.

30. The drive system as recited in claim 28, wherein the spring element has an outer contour, which corresponds to an outer contour of the first and/or second mounting part.

31. The drive system as recited in claim 15, wherein the first and second mounting parts are deformable in order to allow for a tolerance compensation between the drive and the frame component during assembly.

32. A bicycle, comprising:
a drive system including:
an electric drive including a housing; and
at least one first mounting part and at least one second mounting part, which are fastened at the housing and are configured for being fastened at a frame component of the bicycle, wherein the first mounting part is situated at a first side of the electric drive, and the second mounting part is situated at a second side of the electric drive, opposite the first side.
